(19) United States
(12) Patent Application Publication
(10) Pub. No.: US 2001/0052700 A1
(43) Pub. Date: Dec. 20, 2001

(54) Watertight joint and method of sealing drainage and sanitary sewer pipe sections

(76) Inventor: Joseph M. Starita, Marysville, OH (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 09/788,913

(22) Filed: Feb. 19, 2001

Related U.S. Application Data
(63) Continuation-in-part of application No. 09/597,338, filed on Jun. 19, 2000.

(51) Int. Cl. F16L 49/00

(52) U.S. Cl. 285/330

(57) ABSTRACT

A seal and method for forming an in-field watertight seal between rigid pipe sections such as concrete pipe sections by applying on the periphery of a pipe section a continuous bead of a non-sagging gel formed from a curable mixture of low viscosity components. A second pipe section is positioned to form a joint with the first pipe section wherein the gap between mating surfaces of the two pipe sections is filled with the mixture which forms a flexible polymeric elastomer seal upon curing. Physical properties of the components and the seal mixture are disclosed.

### CROSS-REFERENCE TO RELATED APPLICATIONS

This application is a continuation-in-part of my application Ser. No. 09/597,338 filed on Jun. 19, 2000 and entitled “JOINT AND SEAL FOR LARGE DIAMETER CORRUGATED PLASTIC PIPE AND METHOD FOR JOINING PLASTIC PIPE SECTIONS.”

### STATEMENT REGARDING FEDERALLY SPONSORED RESEARCH OR DEVELOPMENT

Not applicable.

### BACKGROUND OF THE INVENTION

This invention relates to seals between rigid pipe sections and methods for on site forming of watertight seals between rigid pipe sections, specifically concrete pipe utilized for drainage and sanitary sewer applications.

Corrugated plastic and steel pipe and reinforced concrete pipe sections are typically used in culvert, storm sewer, and irrigation applications. Drainage applications usually require a “soil tight” or “watertight” joints to prevent or limit infiltration and ex-filtration of soil and water respectively. Reinforced concrete pipe sections in circular, elliptical and rectangular shapes are produced with joining or mating end styles that include tongue and groove or bell and spigot configurations. Tongue and groove and bell and spigot configurations are generally sealed against soils and water infiltration by packing with mastic joint compound, preformed mastic or butyl gaskets or mortar. Reliable watertight joining has been problematic. Over a period of time mastic joint compounds either creep and leak or crack and leak. Pre-formed gaskets tend to require very high axial forces to compress the gasket during the insertion of the tongue into the groove or bell, typically exceeding 1000 pounds. The disadvantages of utilizing pre-molded gaskets for in the field watertight sealing of pipe sections are leaking joints caused by (1) rolling and/or twisting of the pre-molded gasket due to slight misalignment of the adjoining pipe sections and the high frictional forces between the compressing gasket and the pipe wall. This rolling action tends to partially unseat the gasket twisting it and providing a path for water to flow by; (2) shipping and handling damage to the exposed pre-molded gasket. The gaskets are often cut or a piece chipped off during transportation and unloading at the installation site; and (3) a projected area that exerts hydraulic pressure on the pre-formed gasket that forces the joined pipes to separate. The separating force on the joint can be represented by the expression:

F=PA=π(R₀²−Rᵢ²)P

where:

P=internal pressure in the corrugated plastic pipe

π=Pi

R₀=outer radius of the gasket

Rᵢ=inner radius of the gasket.

In a 72-inch diameter corrugated dual-wall pipe with 5-inch deep transverse corrugations, a force of over 1,000 pounds for each pound per square inch of internal pressure acts to separate the mechanical interlocks between joined pipe sections. At 10 pounds per square inch of internal pipe pressure, forces of over 10,000 pounds work against the gasket and to open the joints.

In the past watertight sealing of pipe sections was only specified for sanitary sewer applications. Currently, there exists an increasing trend for the federal, state and local engineers to specify watertight seals for drainage applications. The reinforced concrete, corrugated steel and corrugated plastic pipe industries anticipate legislation that will extend the watertight requirements to all pipe sections utilized for drainage applications.

A bell and spigot joint described by David P. Jones in U.S. Pat. No. 4,084,828 discloses a thin-walled joint face liner ring providing a smooth and continuous face that is applied to the bell or both to the bell and spigot of the reinforced concrete pipe. This has the advantage of giving the pre-molded gasket a smooth surface to slide against when the pipe sections are joined and the gasket compressed. The disadvantages are the additional cost of the bell and spigot ends and lack of reliable watertight performance. Roger Beacom in U.S. Pat. No. 5,687,997 discloses a sealing gasket with lubricant rib and retainer element also having the advantage of lowering the friction during the joining process. However Beacom's invention has the disadvantage also of increased cost and the need to modify the spigot end of the pipe section.

The present invention provides a system and method of joining reinforced concrete pipe sections with benefits including: (1) the joint and method eliminates the projected area that exerts internal hydraulic pressure to open the joint; (2) the joint provides a high performance elastomeric seal insensitive to pipe section alignment during installation and shifts in alignment of the pipe sections may occur post installation; and (3) the joint design and method provides a field-installable watertight seal;

It is a further object of this invention to provide a method for in the field watertight sealing of concrete pipe sections by disclosing a procedure of dispensing a mixture of curable components, capable of forming in situ a polymer elastomer that adheres to the inside of the groove and outside of the tongue forming a watertight seal.

In the method and apparatus of this invention, a mixture of curable components is applied to the joining concrete pipe sections comprising low viscosity components to facilitate convenient dispensing and effective static mixing. The mixture has the capability of forming a chemical thixotrope wherein low viscosity components enter a mixing element and exit having a yield stress sufficiently high that there is no sagging and leveling on vertical and inverted horizontal surfaces and a working time of approximately 10 minutes or longer for joining the pipe and in forming the seal before curing. The mixture cures after the working time by forming chemical cross-links that result in an polymeric elastomer bonded to the surfaces of the joining pipe sections

This invention provides the capability of fabricating on site watertight joints on unmodified commercially available reinforced concrete pipe sections having tongue and groove and bell and spigot designs whereby, enabling the reinforced concrete pipe joints to meet present sanitary sewer and anticipated drainage pipe standards without redesigning and retooling. A polymeric mortar is provided that is formed by mixing low viscosity components that when mixed and applied to a surface of the joining pipe sections adheres to the surface and forms a self supporting gel like consistency. When the pipe ends are brought together the yield stress is exceeded. The polymeric mortar flows and fills the space between the tongue and groove or bell and spigot forming in place an uncured gasket. The polymer mortar then cures to form a resilient elastomeric seal.

The invention is described more fully in the following description of the preferred embodiment considered in view of the drawings in which:

### BRIEF DESCRIPTION OF THE SEVERAL VIEWS OF THE DRAWINGS

FIG. 1 is a perspective drawing of two circular concrete pipe sections having tongue and groove ends.

FIG. 2 is a perspective drawing of two elliptical concrete pipe sections having tongue and groove ends.

FIG. 3 is a perspective drawing of two rectangular concrete pipe sections having tongue and groove ends.

FIG. 4A is a view of two separated representative cross sections of concrete pipe sections.

FIG. 4B is a close up of two separated representative cross sections of concrete pipe sections.

FIG. 5A is a view of two representative cross sections of concrete pipe sections joined together.

FIG. 5B is a close-up cross-sectional view of two representative cross sections of concrete pipe joined together.

### DETAILED DESCRIPTION OF THE INVENTION

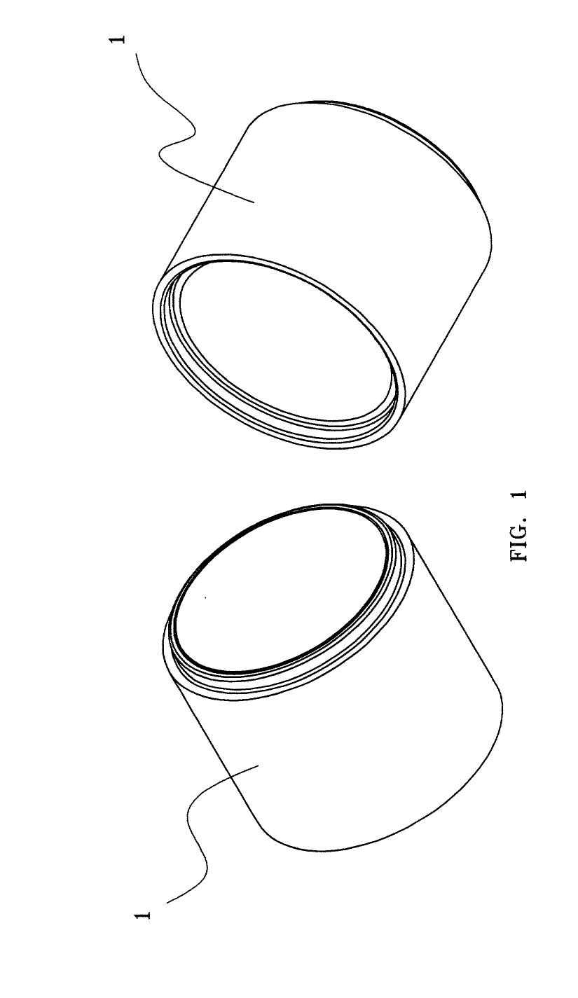

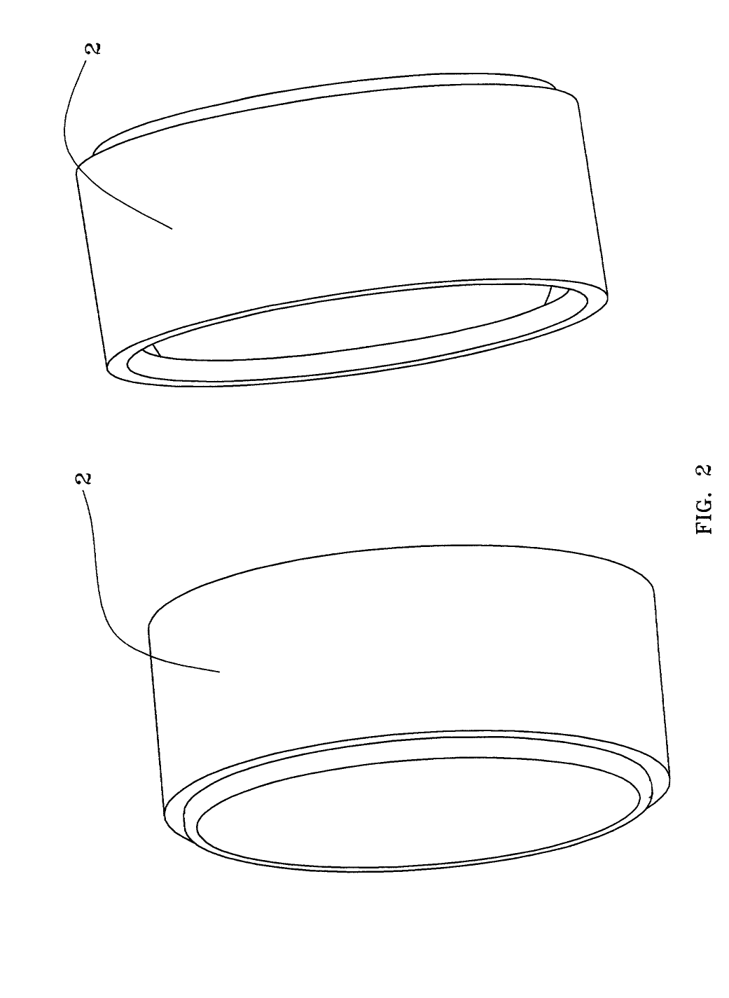

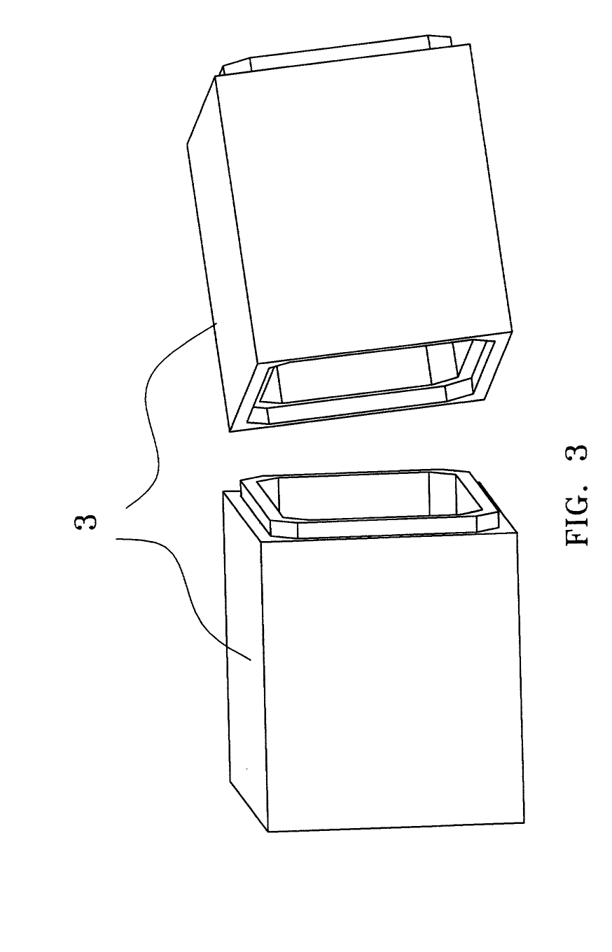

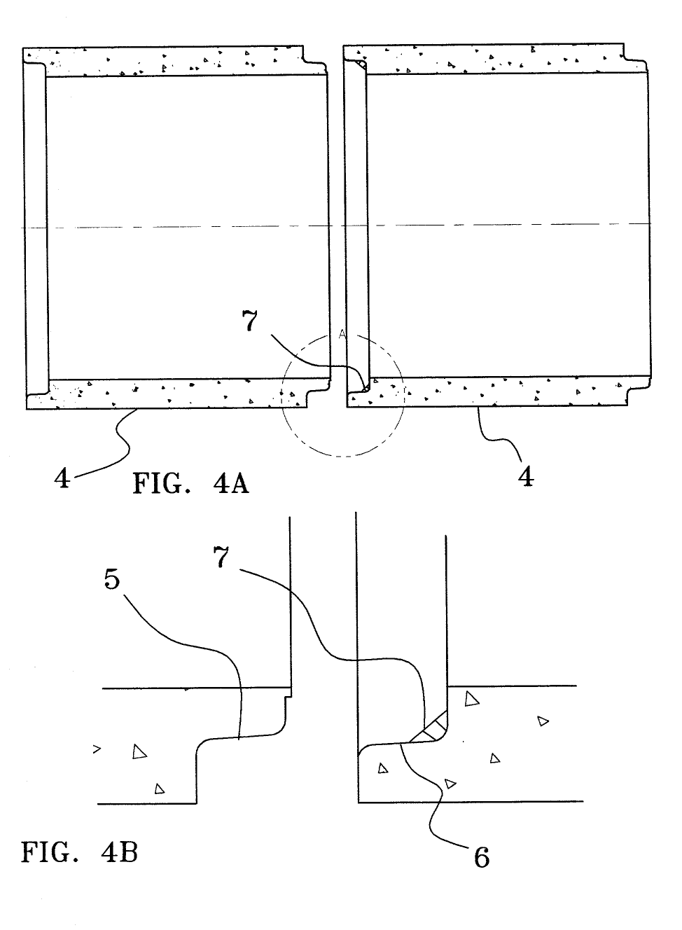

This invention provides a “watertight” joint for concrete pipe sections having mating end sections that are typically referred to as a tongue and groove or bell and spigot. Such concrete pipes are provided in approximate commercial sizes from 12.0 inches to 156.0 inches inside and from 16.0 inches to 182.0 inches outside. Examples of such concrete products are circular pipe sections 1 shown in FIG. 1, elliptical pipe sections 2 shown in FIG. 2 and rectangular pipe sections 3 shown in FIG. 3. FIG. 4A shows a representative cross section 4 for all three concrete pipe sections. The tongue 5 and groove 6 are shown in FIGS. 4A and 4B. This invention utilizes a mixture of curable components 7 capable of forming a non-sagging chemical thixotrope that is dispensed from storage containers by opening a valve that allows the components to enter a static mixer in the controlled ratio. The mixture 7 shown in FIG. 4A and 4B exits the static mixer and is applied to the full peripheral surface of the groove shown. In order to insure convenient and economical dispensing a criterion is applied to value of the viscosity of each individual component of the mixture.

The invention provides a watertight seal for rigid pipe comprising a mixture of curable components capable of forming a polymeric elastomer when applied in a continuous manner to a peripheral surface perimeter of a rigid pipe section located at the end segment thereof. A urethane consisting of polyol and isocyanate is the preferable composition of the mixture. In the invention, two linearly adjacent pipe sections are mated. A first mating pipe section is joined to a second pipe section causing the mixture at the peripheral perimeter of one pipe end to fill the space between the mating ends of the respective sections to form a continuous peripheral seal. Joined pipe sections that are sealed are reinforced concrete including tongue and groove and bell and spigot ends. The mixture of curable components comprises a liquid with a viscosity less than 10,000 centipoise and has physical properties that prevent sagging of the mixture when applied to a horizontal or inverted vertical surface, provided by a chemical reaction between components that create a chemical thixotrope having a yield stress sufficient to prevent sagging on vertical and inverted horizontal surfaces. The applied mixture initiates curing after a working time that results in a continuous peripheral seal of a polymeric elastomer having a hardness on the Shore A scale in the range of approximately 65 to approximately 90.

In the method of the invention, a watertight seal between adjacent rigid pipe sections having co-operatively mating end sections is formed in situ by dispensing a mixture of curable components that form a non sagging continuous peripheral bead on the end section of a first pipe segment. A second pipe segment is joined or mated to the end section of the first pipe segment such that the bead of the mixture fills the gap between the mating end sections of the pipes. The curable components fill the gap between the mating end sections of the pipes and form a polymeric elastomer seal. Thus the invention provides a seal and method for forming an in-field watertight seal between rigid pipe sections such as concrete pipe sections by applying a continuous bead of a non-sagging curable mixture of components on the periphery of a pipe section. A second pipe section is positioned to form a joint with the first pipe section wherein the gap between mating surfaces of the two pipe sections is filled with the mixture that forms a flexible polymeric elastomer seal. Physical properties of the components and the seal mixture are disclosed.

These components have a viscosity sufficiently low to allow small quantity (less than 1 gallon or 4 liters) dispensing through a manual or pneumatic gun having disposable cartridges that contain the unmixed components in proper stoichiometric proportions through a valve and static mixer and/or larger quantity (greater than 1 gallon or 4 liters) dispensing by low pressure (less that five bars) pumping from storage containers through hoses to a valve and static mixing head.

The former requirement is less restrictive such that it is satisfied when the latter is. The criterion for convenient dispensing must satisfy the following condition: η_{c}<πD⁴ΔP/128LQ (Criterion I: for low pressure dispensing)*

where:

η_{c}=Viscosity of a component

π=Pi

D=Inside diameter of the smallest hose (1 inch or 25.4 mm)

ΔP=Pressure drop along the hose length (5 bar)

L=Hose length (25 feet or 7.62 meters)

Q=Volume flow rate (4 gallon per minute or 15.14 liters per minute)

*This expression was derived from the expression Q=πR⁴ΔP/8ηL, which describes fluid flow in a circular pipe. One of many references for this equation is Fluid Mechanics, R. Byron Bird, Robert C. Armstrong and Ole Hassager, John Wiley & Sons, Volume 1, page 14, 1977.

In the preferred embodiment the hose length L of 25 feet (7.62 meters) was selected to be a sufficient length to reach between the containers of the components and the valve and static mixer head in the open trench containing the pipe sections to be sealed. The mixture is dispensed peripherally on the pipe end having the groove already in an open trench. The hose diameter of 1 inch (25.4 millimeters) is a typical commonly available and economical hose size. The result is that each component of the mixture must meet the criterion below:

Component Viscosity=η_{c}<2.69 Pascal-sec=2,690 centipoise

Although in the preferred embodiment, a specific hose inside diameter, hose length and acceptable pressure drop were selected, the above criterion is a general expression. In other words the disclosed criterion provides a general means for determining the maximum acceptable component viscosity for any specific application. This criterion can be used to reject single component systems also. For example, typical acrylic and silicone based caulking components have viscosities at rest that exceed 5,000,000 Pascal-sec and have shear rate dependent viscosities that exceed 100 Pascal-sec. The cost of the caulking compound and the dispensing complexity have created a barrier sufficiently large that caulking compounds are not utilized in sealing large diameter concrete pipe.

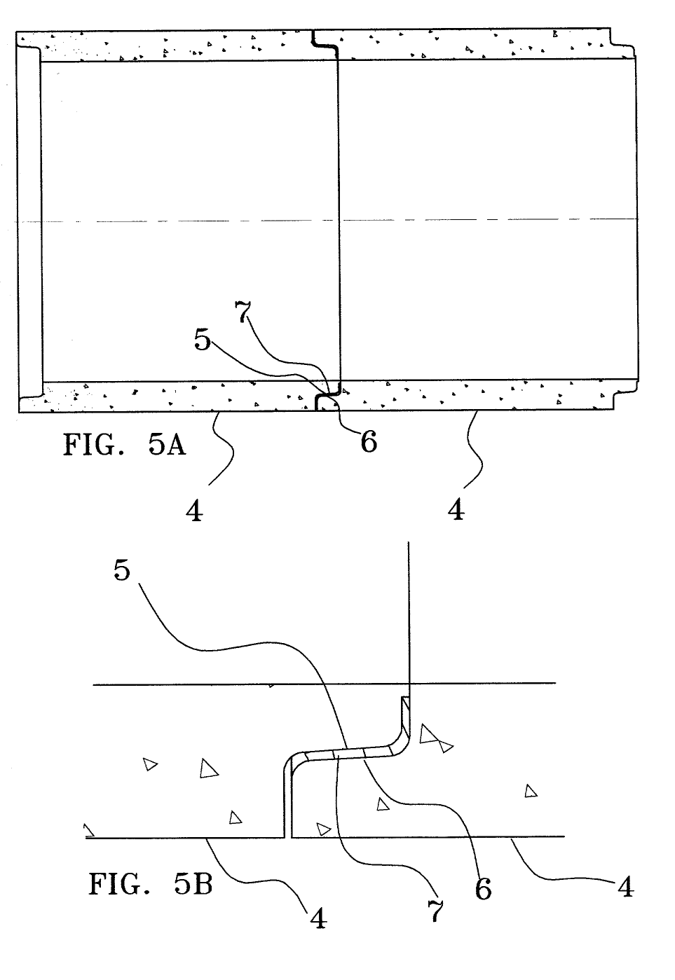

A second non-sagging criterion is required for the mixture of curable components to provide that the mixture stays in place without sagging or dripping. If this criterion is satisfied, the peripheral bead 7 shown in FIGS. 4A and 4B will not distort appreciably from the time mixture was applied to the time the pipe sections are joined. The joined pipe sections are shown in FIGS. 5A and 5B. In these Figures the mixture of curable components is forced to flow radially and axially filling the space between the groove 6 and the tongue 5.

The criterion for viscosity of the mixture of curable components for preventing sagging is:

τ_{y}>ρgh/2 (Criterion II: for non-sagging)*

where:

τ_{y}=Yield stress of mixture of curable components exiting the static mixer

ρ=Density of the mixture of curable components

g=gravitational constant

h=thickness of mixture applied to the groove

*Reference: Analytical Polymer Rheology, Charles L. Rohn, Hanser Publishers, 1995, p207

An example of a mixture of components having a specific gravity of 1.2 is utilized in this example demonstrating the second criterion. This results in a density, ρ=74.92 1 pounds per cubic foot. If h=2 inches then the requirement for the viscosity of the mixture is shown below.

τ_{y}>1.39 psi=9,565 Pa

Typical caulking compounds have yield stress values of approximately 200 Pa explaining why they are not used for sealing concrete pipe. This yield stress criterion was satisfied simultaneously with the component viscosity criterion by utilizing a mixture of chemical components that react within the static mixer to form a chemical thixotrope that is non-sagging. In short the molecular structure is rapidly built so that polymerizing and lightly cross-linking form a gel-like structure with a yield stress sufficient to support the full thickness of the peripheral deposit of the mixture on the interior surface of the groove. Specifically, the preferred method is to fill the inside corner peripherally the mixture 7 shown in FIG. 4A and 4B.

The mixture of curable components preferredly cures after the working time of approximately 10 minutes into a polymeric elastomer with sufficient adhesion to the surfaces of the pipe section and cohesive strength to provide the watertight joint.

In a preferred embodiment, the mixture 7 shown in FIGS. 4B and 5B of reactive components fed are fed mixing and dispensing mechanism not shown from receptacles which may be pressurized and forms an elastomeric polymer having a Shore A hardness of 65 to 90 upon curing in the space filling the tongue and groove or bell and spigot joint. In a specific preferred embodiment, the polymer composition is a urethane formed from a controlled mixing of a polyol resin and an isocyanate promoter. Physical characteristics of the preferred composition include a thickening property and a curing property. In applying the resin/promoter mixture on to the peripheral surfaces at the end of the pipe sections, the mixture should have a thickening property that prevents sagging or dripping and then cures into the a polymeric elastomer within the prescribed hardness range. The components have a viscosity of 100 to 400 centi-poise and develop a yield stress of 10,000 to 30,000 Pascals as it exists from the static mixer. The workings time or time before curing of the mixture exceeds 10 minutes The complete cure occurs over 7-10 days. The elongation to break of the cured elastomeric seal exceeds 50%.

The formed in place flexible elastomeric seal has the advantage of creating a watertight seal that accommodates misalignment at installation and changes in alignment that often occur after installation to underground shifts in the soil supporting the pipe sections.

Alternate embodiments, include sealing pipe sections to other mating fittings and accessories including but not limited to manhole sections, “Y” pipe sections and “T” pipe sections.

Having described the invention in detail, those skilled in the art will appreciate that, given the present disclosure, modifications may be made to the invention without departing from the spirit of the inventive concept herein described. Rather, it is intended that the scope of the invention be determined by the appended claims.

1. A watertight seal for a joint between adjacent sections of rigid pipe comprising a mixture of low viscosity components capable of being applied as a fluid gel having a high yield stress, the gel curing to form a polymeric elastomer, and being applied continuously about a surface on an end segment of a rigid pipe section, and allowed to fill the interstitial space between adjacent sections when the sections are joined.

2. The seal of claim 1 in which the mixture is applied to an inner surface at an end segment of a pipe.

3. The seal of claim 1 in which the mixture is applied to an outer surface at an end segment of a pipe.

4. The seal of claim 1 in which the mixture is applied to an end surface at an end segment of a pipe.

5. The seal of claim 1 wherein the mixture is a urethane consisting of polyol and isocyanate.

6. The seal of claim 5 wherein two linearly adjacent pipe sections are mated and in which a first mating pipe section is joined to the second pipe section causing the mixture at the peripheral perimeter of one pipe end to fill the space between the mating ends of the respective sections to form a continuous peripheral seal.

7. The seal of claim 3 wherein the pipe sections are formed from reinforced concrete.

8. The seal of claim 4 wherein the pipe sections include tongue and groove ends.

9. The seal of claim 4 wherein the pipe sections include bell and spigot ends.

10. The seal of claim 1 wherein the mixture of curable components comprises a liquid with a viscosity less than 10,000 centi-poise.

11. The seal of claim 10 wherein the mixture has physical properties that prevent sagging of the mixture when applied to a horizontal or inverted vertical surface.

12. The seal of claim 11 in which the non-sagging property of the mixture is provided by a chemical reaction between components that creates a chemical thixotrope having a yield stress sufficient to prevent sagging on vertical and inverted horizontal surfaces.

13. The seal of claim 12 wherein the applied mixture initiates curing after a working time that results in a continuous peripheral seal of a polymeric elastomer having a hardness on the Shore A scale in the range of approximately 65 to approximately 90.

14. A method of forming in situ a watertight seal between adjacent rigid pipe sections having co-operatively mating end sections comprising:
(a) dispensing a mixture of low viscosity curable components that form a non-sagging continuous peripheral bead at the end section of a first pipe segment;
(b) joining a second pipe segment to the end section of the first pipe segment such that the bead of the mixture fills the gap between the mating end sections of the pipes;
(c) allowing the curable components filling the gap between the mating end sections of the pipes to form a polymeric elastomer bonding to the surfaces at the end sections.
